(19) United States
(12) Patent Application Publication
(10) Pub. No.: US 2018/0197212 A1
(43) Pub. Date: Jul. 12, 2018

(54) AUTOMATED AD SPACE LEASE AND MANAGEMENT SYSTEM

(71) Applicant: The Pluggedin Group LLC, Philadelphia, PA (US)

(72) Inventor: Aisha WHITMAN, Philadelphia, PA (US)

(21) Appl. No.: 15/504,891

(22) PCT Filed: Aug. 21, 2015
(86) PCT No.: PCT/US15/46394

§ 371 Date: Feb. 17, 2017

Related U.S. Application Data
(60) Provisional application No. 62/040,458, filed on Aug. 22, 2014.

(51) Int. Cl. G06Q 30/02; H04L 29/06; G06F 17/30

(52) U.S. Cl. CPC G06Q 30/0277; G06F 17/30864; H04L 63/08; G06Q 30/0275

(57) ABSTRACT

The present invention provides methods for authenticating a plurality of users, receiving a plurality of Internet-based ad spaces, storing the plurality of Internet-based ad spaces, and posting the ad spaces for the sale, exchange, auction, or lease of the ad spaces to other users. The present invention also provides for products produced by the methods of the present invention and for systems and apparatuses used to perform the methods of the present invention.

### CROSS-REFERENCE TO RELATED APPLICATIONS

This application claims priority to U.S. Provisional Application Ser. No. 62/040,458, filed Aug. 22, 2014, the contents of which is hereby incorporated by reference in its entirety for all purposes.

### FIELD OF THE INVENTION

The disclosed invention is in the field of internet advertising.

### BACKGROUND OF THE INVENTION

Advertising on the internet has created a method of advertising that is more complex than what most users are comfortable with. Users need to not only create an account and choose keyword permutations, but also must invest more money and create more dexterous lists of keywords to get their ads seen by their target group. A goal in popular ad space marketing is to see how much more an advertiser will pay for the same keywords that many other advertisers are using to get their ad seen. For example, there are many services emerging where the service's sole product is to place advertisements similar to electronic billboards on ad spaces on popular websites. Generally, the more an advertiser pays, the more the advertiser is seen. The amount an advertiser needs to pay to be guaranteed to be seen will continue to elude advertisers that are watching the cost of this service rise without the guarantee of increased ad space-placement effectiveness.

It is also difficult for advertisers to be capable of finding their ad locations because the locations are constantly varying and out of the control of the advertiser. There is also a lack of reliable methods to perform enough market research on a possible ad space before committing to an ad campaign in that ad space. Additionally, the process of checking how an ad space is performing is not simple, and performance details are not comprehensive enough without paying extra for the service. Finally, the existence of illegal Application Program Interfaces (APIs) that trawl for ad space keywords to attract advertisement and illegally hijack ad spaces act as black holes for advertisements on the internet.

Thus, there is a need for methods and systems to lease and manage ad space on the internet. The invention is directed to these and other important needs.

### SUMMARY OF THE INVENTION

The present invention provides methods comprising: authenticating a plurality of users via an Internet-based interface; receiving a plurality of Internet-based ad spaces from the plurality of users after the authenticating; storing the plurality of Internet-based ad spaces after the receiving; and posting the ad spaces for the plurality of authenticated users to view after the storing.

The present invention also provides systems that perform those methods. The system may comprise a server, and the server may comprise at least one computer communicatively connected to a computer network and communicatively connected to a database. The server may have stored thereon computer instructions that during execution cause the system to perform operations comprising: authenticating a plurality of users via an Internet-based interface; receiving a plurality of Internet-based ad spaces from the plurality of users after the authenticating; storing the plurality of Internet-based ad spaces in the database after the receiving; and posting the ad spaces for the plurality of authenticated users to view after the storing.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 illustrates a flow diagram of operation of an embodiment of the present invention;

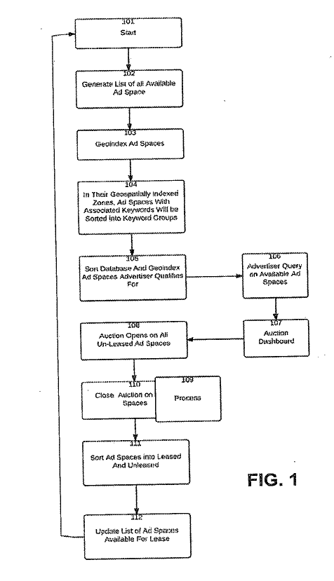

FIG. 2 illustrates an embodiment of the present invention directed to an Auction Management System selection of advertiser's qualified ad spaces;

FIG. 3 illustrates an embodiment of the present invention directed to geospatial indexing of ad spaces;

FIG. 4 illustrates an embodiment of the present invention directed to a process of becoming an eligible advertiser and using an advertising system;

FIG. 5 illustrates an embodiment of the present invention directed to an ad space auction format and method of operation;

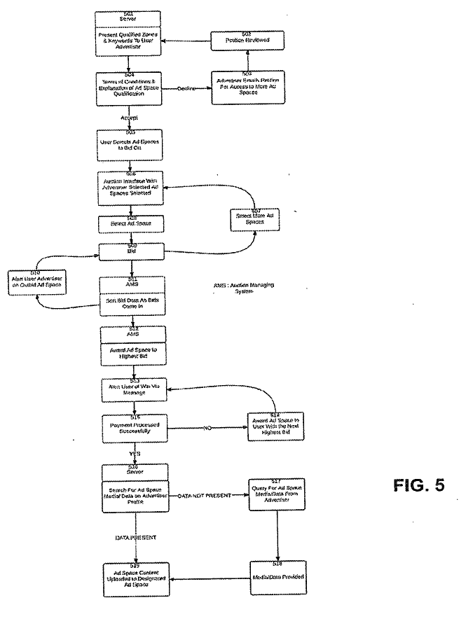

FIG. 6 illustrates an embodiment of the present invention directed to a process for advertisers to list and sell ad spaces;

FIG. 7 illustrates an embodiment of the present invention directed to a graphical user interface pop-up screen notifying a user that bidding has closed on an ad space;

FIG. 8 illustrates an embodiment of the present invention directed to a graphical user interface displaying an advertiser dashboard;

FIG. 9 illustrates an embodiment of the present invention directed to a graphical user interface displaying an auction dashboard; and

FIG. 10 illustrates an embodiment of the present invention directed to an analytics subscription process diagram.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. Any reference to a masculine term, e.g., “he” or “his,” also includes the feminine term, e.g., “she” or “hers,” and vice versa unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

The solution disclosed herein includes methods comprising: authenticating a plurality of users via an Internet-based interface; receiving a plurality of Internet-based ad spaces from the plurality of users after the authenticating; storing the plurality of Internet-based ad spaces after the receiving; and posting the ad spaces for the plurality of authenticated users to view after the storing.

The solution disclosed herein also includes systems comprising a server, the server comprising at least one computer communicatively connected to a computer network and communicatively connected to a database, the server having stored thereon computer instructions that during execution cause the system to perform operations comprising: authenticating a plurality of users via an Internet-based interface; receiving a plurality of Internet-based ad spaces from the plurality of users after the authenticating; storing the plurality of Internet-based ad spaces in the database after the receiving; and posting the ad spaces for the plurality of authenticated users to view after the storing.

Disclosed embodiments also provide methods for use on such systems for presenting an online advertising forum in which access to the breadth of a given advertisement's exposure to viewers/the market is determined by a number of factors, including but not limited to, the geospatial category of the physical business location of the advertising firm and the level of the purchase cash commitment for ad space that allows the broadening of the geospatial scope of the advertisement's placement. Disclosed embodiments also include an auction-style method for the presentation, management and sale of available ad space.

Embodiments in this disclosure include the ability to auction off multiple ad spaces that target an advertisers' specific geospatial area and keywords associated with the advertisers' type of business.

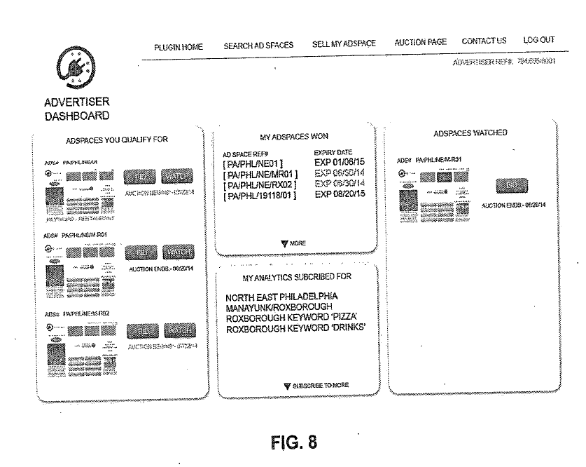

Ad space content is relevant to its advertisers' geospatial area and business type. The advertiser bidding is able to view what ad spaces he qualifies for based on his business type, geographic zone, and available ad spaces for that zone ahead of the auction. An example view can be seen in FIG. 8.

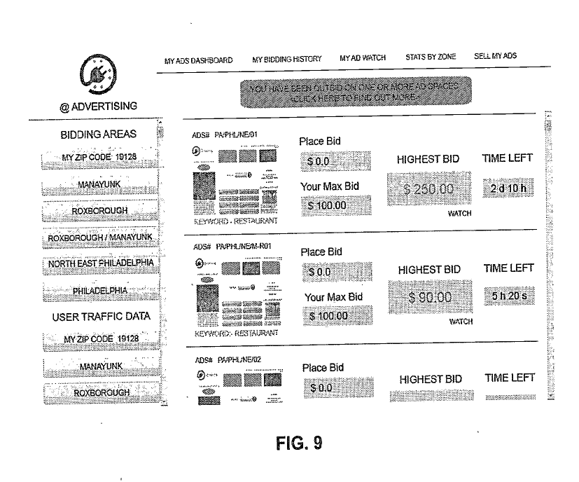

Embodiments disclosed herein streamline and automate advertising while making the advertisements geospatially and business-type keyword specific. Any ad space displayed on a web page that is for a specific town should have advertising geospatially specific for that town, with ads related to the content of that page. For example, a search for kids' activities in Ardmore, Pa., may have an advertisement for Olly Kids Shoes in Ardmore, Pa., instead of Toys R Us in King of Prussia, Pa. However, a geospatial search that included both Ardmore and King of Prussia allows for Toys R Us and Olly Kids Shoes to compete anonymously in an auction for that same geospatial ad space. FIG. 9 displays the indexing of ad spaces by geospatial region.

Embodiments allow for market-driven pricing of advertisement spaces. With a reserve price of, for example, $0.00, potential advertisers/bidders may determine, upon the success of a given bid for an ad space, what the actual market value is for that space. FIG. 9 shows an example auction page.

Disclosed embodiments do not require human-driven sourcing for potential advertisers. Potential advertisers may be required to solicit membership into an advertising portal and complete geospatial data fields within the membership application. After human verification of the accuracy of an application, member advertisers have access to online search traffic activity for the geospatial zone in which they have enrolled. This allows a potential advertiser to determine visibility and possible geospatial search engine optimization for the ad which he is attempting to post, thereby maximizing his investment in the ad space.

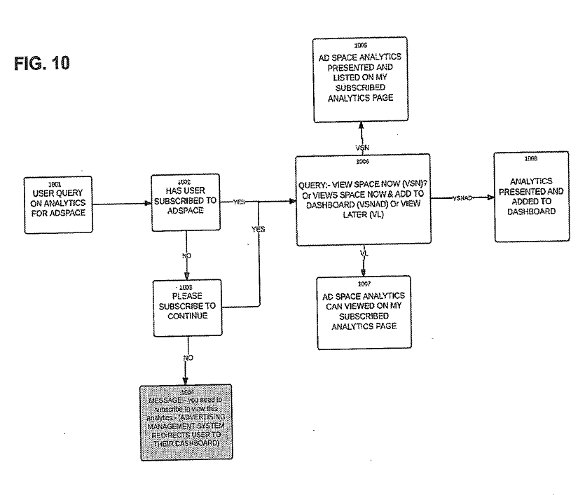

Embodiments also include the ability for advertisers to “window shop” for potential ad spaces by reviewing displayed analytics, whether historic or in real time. The process for querying analytics can be seen in FIG. 10.

In other embodiments, ad space positioning is not necessarily relevant to an advertiser's physical location. A potential advertiser is able to view all ad spaces of interest throughout the internet. Such embodiments streamline and automate advertising on the World Wide Web. These embodiments do not require human driven sourcing for potential advertisers. An advertising management system allows member advertisers to have access to all browsing activity relevant to the ad spaces to which they have indicated are of their interest. This allows a potential advertiser to determine placement optimization potentials for the ad which he is considering. Some such embodiments allow for market-driven pricing of advertisement slots. A reserve price of $0.00 allows potential advertisers/bidders to determine, upon the success of a given bid for an ad space, what the actual market value is for that space. Some embodiments may also allow those who have the rights to sell a named ad space, to also have a “buy it now” aspect to their sale if they so choose.

Embodiments of the methods and systems treat ad spaces like real estate. If an advertiser rents an ad space at a specific location, the advertisement will be at that specific location. Disclosed embodiments eliminate the need to have extensive knowledge of the keyword dynamics necessary in current cost-per-click ad space marketing. Embodiments also allow advertisers to be able to perform market research on specific ad space addresses and locations before committing to lease, buy, or bid on the ad space.

Further, embodiments allow advertisers to buy, sell, auction, and exchange ad spaces on an open market. Ad space prices are market driven. Therefore, inflation and deflation of ad space values will be dependent on supply and demand and will be completely transparent. The valuation of performance of the ad spaces are simpler and part of the purchase package. If the advertiser wins the ad space, the advertiser may be provided with details of the ad space's performance until the close of the lease.

Embodiments provide brokerage of ad spaces present on the World Wide Web, online-dependent applications, programs, platforms, websites, or any other interrelated systems having ad spaces which may or may not be included in an auction-style, sale, or exchange management system (collectively “web platforms”).

Disclosed embodiments provide access to ad spaces on web platforms by giving preference to businesses that are physically located within the given geospatial zone of a given user's query. Embodiments include two types of ad space, both of which have multiple geospatial permutations. The first type of ad space is an advertisement position located on a geospatial dashboard of a user query (406). The second type of ad space is an advertisement position on a given user's geospatial-specific keyword query result page (406). For the first type, there are three (3) ad spaces available (2041-2075), and for the second type, there are two (2) ad spaces available (204, 205, 206, 207).

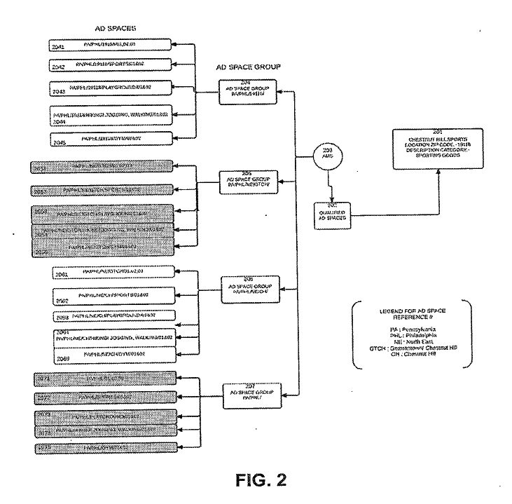

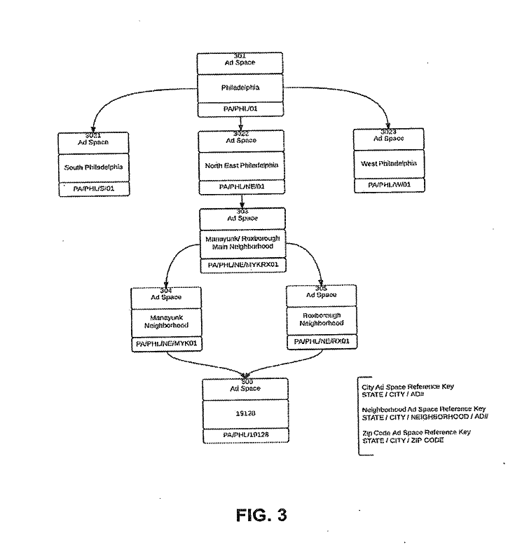

In the case of a geospatial dashboard-presented ad space, a hierarchy is created according to the level, or tier, of the geographical zone of the geospatial query, as exemplified in FIGS. 2-3. For example, a tier 1 geospatial dashboard ad space is associated with the most basic type of geospatial indexing of a physical geographical zone (204, 205, 206, 207). The broader the user chooses to make his/her geospatial query, the broader the indexed geospatial specific data presented; hence, the higher the tier of an advertisement's placement, the higher the likelihood of a user viewing interfacing with (reading/clicking) the advertisement. The keywords to drive a given geospatially oriented search are numbered at approximately 300, and a search thereupon operates on a carousel basis, allowing specific advertisements to appear when a set of one of these predetermined 300 words is queried.

Embodiments allow potential advertisers to have access to a marketplace for ad space, thereby creating an advertising purchase forum that needs no human brokering. The default starting price for auctioned ad space owned by the web platform regardless of tier is, for example, $0.00, thereby causing and allowing ad space to be market driven. Embodiments require potential advertisers to register by completing several data fields, including exact geospatial information of the business being advertised. Each potential advertiser is then given a selection of geospatially tiered advertising available to him based on business type and location, and he may bid against other potential advertisers for an ad space (406, 407, 408, 409). Once a successful auction is closed, the advertiser submits his advertisement to the database operator (108, 109). The winning advertiser then has his active ad or leased ad space displayed on a private interface; for example, an “advertiser's dashboard” may allow him to view, among other things, his ad space's real-time and historic analytics. FIG. 8 displays an example advertiser's dashboard. Advertisers and potential advertisers have access to view analytics regarding ad spaces made available and managed by the ad space marketplace.

Embodiments may also provide comprehensive management of formal or informal internet-wide, platform-unlimited, and non-specific ad space real estate as an agent, broker, and general entity that presents, manages, exchanges, and sells online ad space (“broker”). Such embodiments may provide brokering for any or all ad spaces on the World Wide Web, regardless of platform, and may operate similarly to the geospatial hierarchy marketplace described above without the geospatial-specific qualities. Advertisers and potential advertisers may have the ability to buy, sell, and exchange ad spaces, auction ad spaces, and view analytics for specific ad spaces and ad space categories. Advertisers on certain platforms may have access to those ad spaces presented only by that platform. However, embodiments of this disclosure are not limited to only one platform; brokering may be performed on all spaces on the World Wide Web.

Embodiments include an auction management system (“AMS”), which refers to a back-end system or methods of the way ad space real estate auctions are handled. An AMS may be entirely automated, eliminating the need for human interaction with the process and allowing auctions and subsequent transactions to occur instantly upon their validity. Further, an AMS may include a variety of features and functions.

An AMS may index ad space availability based on geospatial and keyword-related data of available pages. For example, ad space #1 in the geospatial zone of Northeast Philadelphia may be indexed as PA/PHL/NE/01. In FIG. 3, this ad space falls under the “Philadelphia” hierarchy and is listed in FIG. 8 under the “MY ADSPACES WON” section. In the case of keyword-driven ad space, the index code may be identical except for an additional and final reference indicator of that keyword. For example, an index code might be PA/PHL/NE/01/RESTAURANT.

An AMS may determine advertisers' eligibility for ad spaces based on the advertisers' geospatial positioning and business description category, which the AMS uses to associate the advertisers' eligible ad spaces with appropriate keywords. For example, Chestnut Hill Sports may identify itself as located in Chestnut Hill and as a sporting goods store, which the AMS uses to determine that the business is eligible for ad space on any geospatial dashboard having to do with Chestnut Hill and any keyword search having to do with sporting goods, as shown in FIG. 2 (2051-2055, 2061-2065).

An AMS's Internet-based user interface may change depending on a given users preferences. At the request of an advertiser, the advertiser's AMS may structure and install advertiser-specific options for presenting, monitoring, and bidding on auctions and available ad spaces that are currently being auctioned or will be auctioned in the future. Example AMS interfaces may be seen in FIGS. 8-9.

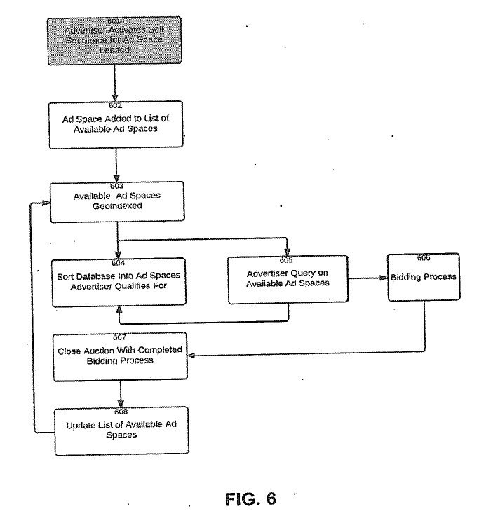

An AMS may monitor ad space availability unique to each advertiser (103, 104). An AMS may also monitor and operate each auction by receiving bids and accordingly updating the auction, as well as maintaining accurate timeframe information for the auction. A flow diagram of the monitoring and operating may be seen in FIG. 6, and an example AMS showing available auction sites may be seen in FIG. 9. (108-112) (407) (510-519).

An AMS may also manage the bidding process and act as an ad space procurement manager. It may receive and process multiple bids for a given ad space (511, 512) (603-608), award multiple ad spaces to multiple auction winners simultaneously (512, 513), and administrate ad uploading and posting (516, 519). This allows the input method of the auction, sale, and exchange of ad spaces to be derived from ad space sellers being able to upload ad space data from various online platforms or a single online platform to the system to categorize and/or index and post for auction, sale, or exchange. Further, ad spaces for a specific web platform may be automatically categorized, indexed, and uploaded for auction, sale, or exchange. Ad spaces uploaded by verified web platform owners may be presented for auction, sale, or exchange without verification that the ad space is empty unless the ad space was previously managed by the AMS. Web platform owners uploading ad space may also set a time-related deadline for the auction, sale, or exchange of the ad space and may optionally choose a start time for the auction, sale, or exchange, which may be immediately or at a future time.

Uploads may be stored in a data repository, or database, associated with an AMS. Uploads may include the ad space size, ad space location, whether the ad space is for auction, sale, or exchange, terms, time duration, commencement, end of auction, sale, or exchange of the ad space, description of the ad space for auction, sale, or exchange, screenshot of ad space placement, and where the AMS is able to track the user click data and analytics for the ad spaces uploaded and stored in the data repository associated with the AMS.

An AMS may also generate various alerts based on advertisers' alert requests, which may be in a pre-determined user-preferences index. The AMS may also generate various emails based on the pre-determined user-preferences index of advertisers' alert requests, including email notifications of winning bids, outbid notices, auctions' openings and closings, and other information relevant to advertisers' information needs regarding auction activity.

When conducting an auction, exchange, or sale, the AMS in use may have all data on the ad space being processed and presented in various formats, including internet-dependent-devices format, for a user interested in procuring the ad space to review. The AMS then receives and processes, from buyers over the internet, procurement data corresponding to specific ad spaces within the system. It identifies that an ad space for auction has been bid on, processes the valid input, and updates the displayed price instantaneously to reflect ascending values input by various ad space buyers. The AMS receives and processes various auction inputs from various internet bidders and terminates the auction on time lapse close. It then identifies that an ad space for sale has been purchased, removes the ad space from the ad space sale database to be processed on completion of sale, and indexes the ad space as sold. After identifying that terms of exchange have been met, the AMS sends notifications to the ad space seller to process the ad space based on the terms of exchange.

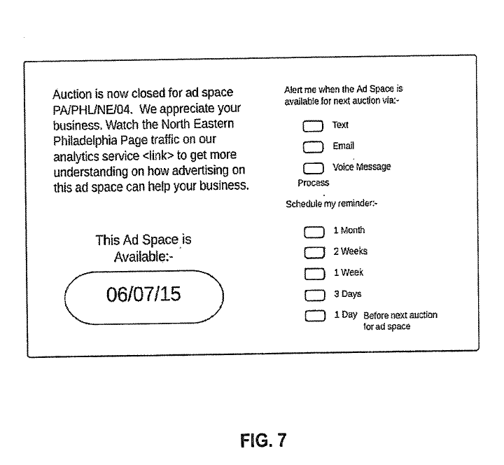

Once an auction is won, an AMS may save the profile of options (e.g., a double or triple lease period) given to the winning bidder for that ad space and subsequently administrate the lease based on those preferences. An example administrative pop-up after an auction is shown in FIG. 7.

An AMS may also recycle unsuccessful auctions according to the next available ad space auction timeframe (607, 608, 603). An unsuccessful auction is one in which no bid was placed.

Additionally, an AMS may save and distribute relevant financial information, such as winning bid values, for use in billing (513, 514, 515).

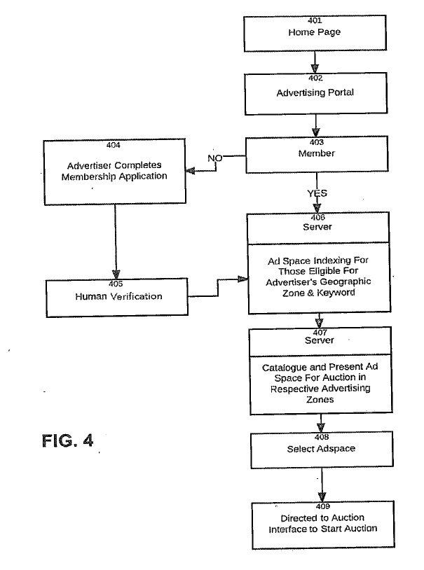

Before using an AMS, an advertiser must first become an eligible advertiser, or “member” as shown in FIG. 4. To become an eligible advertiser, the applicant's business must be registered with the system and the applicant must agree to the terms and conditions of ad space auction procedures. An applicant may be required to fill out a form that goes through a human verification process, as shown in FIG. 4. Such a form may have, but is not limited to, the following fields: Geospatial field of the business; Photo of business (street view and interior); Contact information including business phone number, address, fax number, email address, etc.; Website, if any; Days and hours of operation; Nature of business; Brief description of business; Category of business as selected from a list; Name of agent permitted by the business to act on its behalf as the advertising agent; Contact information for this advertising agent; Name of supervisor responsible for granting permission to advertising agent to represent the business in all advertising matters pertaining to the advertising on the AMS; Supervisor's position in company; Contact information for such supervisor, including email and phone number; and Government classification number, which the AMS can use to verify that the business is registered. The applicant must also choose a payment method for when he wins an auction.

After the form is completed and submitted, the business information will go through a verification process to determine if the business is licensed or registered, if the business exists in the location it has specified, and if the named advertising agent indeed legally represents the advertising interests of the business for matters pertaining to advertising on the AMS. This process is to ensure that legal consent has been given for the system to manage the ad space. The web platform owner possesses the ad space, the AMS manages the ad space on behalf of the web platform owner/possessor and its authorized seller or manager by virtue of legal consent by the web platform owner for the ad space(s) until the auction, sale, or exchange process is complete. The AMS may also manage the ad space for the duration of the lease, exchange, or sale terms for the presented ad spaces(s) for that specific owner. Stated differently, the AMS, acting as a procurement manager, may legally control and manage ad spaces leased or exchanged by the AMS for the duration of the ad space lease or possessor's interest, by virtue of legal consent by the web platform owner. Without web platform owner verification, the AMS will not aggregate data regarding the ad space and present the ad space for auction, sale, or exchange. A similar verification process may be used for buyers as well as sellers to ensure that ad space is being bought by a real entity.

After verification, an AMS may store all input data on approved potential buyers and sellers of ad spaces in a database of members. Users may not be able to view the contents of the database of ad spaces until after they input valid login credentials, allowing the AMS to recognize the user as a valid, potential buyer or seller. Logging in allows potential buyers to view a web user interface displaying data on ad spaces available for auction, exchange, or sale and bid, exchange for, or buy such ad spaces.

Legal consent, either by the web platform owner or the AMS as its agent, may also be required to allow subleasing of space. Ad spaces leased with the AMS may be auctioned, sold, or exchanged for the remaining duration of the lessees time period with legal authorization from the owner or its agent. A winner of such an ad space would have the remaining time of the original lease to post an advertisement.

If an internal monitoring process of an AMS detects fraud, it may revoke the license, or login credentials, of the fraudulent web platform owner or buyer and refuse to let that owner or buyer sign in, login, upload ad space data, sell, auction, exchange, buy, or bid on ad spaces within the AMS.

Embodiments may include different AMS interfaces, each of which may include different menus and sections. Two such sections, or “dashboards,” include the Advertiser Dashboard and the Auction Dashboard. Regardless of interface, all ad spaces may be displayed alongside their respective geospatial index number and, if keyword-associated, keyword index number for uniformity.

An AMS also includes an electronic auction for ad space that comprises an advertiser dashboard. The Advertiser Dashboard may be the first thing an advertiser sees after completing the advertising-membership process. The Advertiser Dashboard is the resource page for the advertiser and provides the advertiser with various links and information. This dashboard displays ad space available to the advertiser user/member and information on the search traffic behavior for the zones for which the advertiser qualifies. An example Advertiser Dashboard may be seen in FIG. 8.

The Advertiser Dashboard may have a “Settings” link that allows the advertiser to customize aspects of his dashboard (e.g., whether the advertiser wants all of his leased ad spaces displayed on his dashboard or a link to the list of their leased ad spaces), view his account, upload or change the advertising media for his ad space, set up his alerts, and set his choice mode(s) of communication between the AMS and himself.

The Advertiser Dashboard may list an advertiser's leased ad spaces with an expiry date or a displayed timer counting down to the expiry date of ad space lease. Such a list may be customized by advertisers' settings to be displayed as a list or a link to a list. FIG. 8 shows an expiry date in lieu of a counting timer.

The Advertiser Dashboard may show a current list of an advertiser's active bids. This list may also be customized by advertisers' settings to be displayed as a list or a link to a list. FIGS. 8-9 show example Advertiser Dashboards.

The Advertiser Dashboard may include an advertiser's existing leased ad space information, which may be customized by advertisers' settings to be displayed as a list or a link to a list. FIG. 8 shows this information under “MY ADSPACES WON”.

The Advertiser Dashboard may also include other links, such as a live link to the web page(s) on which the advertiser's active leases are displayed, a link to leased ad space analytics, a link to analytics to which the advertiser has subscribed, a link to a sign-up page for additional geospatial and/or keyword specific analytics, and a link to an Auction Dashboard. In FIG. 8, the text items under “MY ADSPACES WON” and “MY ANALYTICS SUBSCRIBED FOR” may act as some of these links.

The Auction Dashboard may be accessed by a link from the Advertiser Dashboard, or by any other capable means, and primarily displays the list of live auctions in which the advertiser is engaged. It may also include a categorized list of ad spaces for which the advertiser is eligible, categorized geospatially or otherwise. The Auction Dashboard may also include other links. One link may lead to user traffic data (analytics) corresponding to eligible ad spaces, which may also be categorized geospatially. Access to analytics of a given eligible ad space is restricted to subscribed users or the user owning the lease of the ad space. This process can be seen by the flow diagram of FIG. 10. Other links may include a link back to the Advertiser Dashboard; a user's bidding history; and a list of “watched live auctions,” which becomes active when advertisers choose to bid. Upon activation, the auctions appear as active auctions in which the advertiser is participating.

Dashboards may be customizable. Buyers or sellers (“users”) of ad spaces may want all leased ad spaces display on the dashboard or a link to the list of spaces. They may want to view their account details and settings, upload or change the advertising media for their ad spaces, create alerts and reminders, and set the mode of communication between them and the AMS. Dashboards may also give users the ability to upload media, e.g., images or videos, for their ad spaces and edit the media and details of advertisements to be posted to leased ad spaces. Users may also want timers displayed so they know when their leases expire.

Dashboards should contain various items for users. The following comprise a list of features that may be implemented in one or more dashboards, and embodiments may include more or less features than those specified. Dashboards should contain a current and constantly updating list of a user's active bids with a current price and displayed timer counting down to the expiry date/time of the auction, sale, or exchange of each ad space the user has an active bid on. Each time there is a bid, the current price should be instantaneously updated so that all users know the current bid. On the active bids list, a user may continue his bidding activity by inputting a bid higher than the current displayed value for each ad space until the auction is won. Inputting may comprise clicking a link. Dashboards should also include a search option for the users to sort through ad space data presented to them by the AMS and make selections for bookmarking any ad spaces that they are interested in, which may be added to a list of the user's interested ad spaces. The search option should also contain an option for a user to make selections for procurement action. For ad spaces a user is interested in, the Dashboard should have: (1) if an auction is occurring, a countdown indicating when the time period for possible procurement will end; (2) if the ad space is currently leased, a countdown indicating when the current ownership interest will end; (3) if the ad space is up for exchange, the exchange terms to be met; or (4) if the ad space is up for sale, the sale price and ability to process the user as a buyer of the ad space. Ad spaces on a user's interest list may also include the analytics and click data associated with each ad space. Dashboards should also contain current lease information, including expiration date and time of leased ad spaces.

As described previously, embodiments include an AMS that facilitates auction-style bidding and a method for providing such an electronic auction system for advertisers that is geospatially specific and comprises, but is not limited to, the following aspects. The AMS may include market driven online advertising that targets user-markets based on advertiser-geospatially-specific locations of a physical business or a radius within which the business provides services (501) (406, 407) (102-104). It may also provide advertisers access to user search activity pertaining to the advertisers' geospatial zones and aggregations of areas which contain the advertisers' base-layer zone (e.g., zip code). The process of accessing those analytics may be seen in FIG. 10. The AMS may also allow advertisers to re-auction their ad spaces.

An AMS includes an electronic auctioning system that receives bids from a number of prospective advertisers for a number of different ad spaces. Based on the highest bid received by the close of the auction, the system awards ad spaces to each space's highest bidding advertiser. If the winning advertiser defaults on his payment, the ad space goes to the next highest bidder. This cycle repeats itself until the payment process is completed by an advertiser. (509-5515). FIG. 9 shows an example auction.

The beginning of an auction is ad space-duration sensitive. This means that an auction will only begin when there are ad spaces available for auction. The duration of the ad space is important information that is always displayed with the corresponding ad space listing. For example, if all ad spaces are leased, the next available auction will occur 7 days prior to the expiration of ad spaces' lease. (111, 112) (608) Any ad spaces not bid on by close of auction will be sorted by the AMS and re-posted into the next available auction. (110, 111, 101). Finally, advertisers have the option, within a short timeframe upon winning an auction, to double or triple their lease duration and maintain the ad space for the extension of time based on the monetary value of their winning bid.

Embodiments include a web platform analytics service. This service allows the advertiser access to user clickstream data both prior to and during a lease of ad space. Once an advertiser has claimed a lease on an ad space, no other advertiser may view the analytics for that specific space. The clickstream data gathered in this onsite analysis service may give the following information via the process shown in FIG. 10: Total users that have access to various pages within the monitored web platform; Search history/traffic/time sensitive traffic density of users, including keyword queries by users that yield results as well as those that do not yield results; How many of the users were members; and if members, a census of members according to profile categories recorded in membership application fields.

Accordingly, gathering clickstream data begins at the time the web platform goes live and may include the following: Quantity of visits to web platform Homepage; Quantity of visits to each page of web platform; User traffic direction within the web platform; and Time sensitive user traffic density within the web platform. Once ad spaces are leased, clickstream data will include the quantity of clicks on each ad space as well as census information of the members who clicked.

Applications of web platform analytics include market research and the ability to discern the quantity of visits to each page containing ad space as well as the quantity of clicks on ads leased by advertisers.

The above-described features, systems, and methods may be combined together in various forms and combinations. The following example embodiment is one such combination. An embodiment may allow a user to view ad spaces categorized in various sections for the user to review analytics and user click data for presented ad spaces, buy multiple presented ad spaces, bid for multiple presented ad spaces, exchange user owned ad spaces for multiple presented ad spaces, review analytics and user click data for a presented ad space, buy a presented ad space, and exchange a user owned ad space for a presented ad space. An AMS may manage any or all of the ad spaces and facilitate any or all of these transactions.

The disclosures of each patent, patent application, and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A system comprising:
a server, the server comprising at least one computer communicatively connected to a computer network and communicatively connected to a database, the server having stored thereon computer instructions that during execution cause the system to perform operations comprising:
authenticating a plurality of users via an Internet-based interface;
receiving a plurality of Internet-based ad spaces from the plurality of users after the authenticating;
storing the plurality of Internet-based ad spaces in the database after the receiving; and
posting the ad spaces for the plurality of authenticated users to view after the storing.

2. The system of claim 1, the server having stored thereon computer instructions that during execution cause the system to perform operations further comprising:
auctioning at least one of the plurality of Internet-based ad spaces for bidding by the authenticated users.

3. The system of claim 2 wherein auctioning begins immediately after storing or a future time after storing.

4. The system of claim 2 wherein auctioning comprises:
identifying the ad space for auction has been bid on;
processing a valid input price from an authenticated user;
updating a displayed price instantaneously to reflect the valid input price; and
terminating the auction after a predetermined amount of time.

5. The system of claim 4 wherein auctioning further comprises:
identifying the ad space for auction has been purchased;
removing the ad space from posting;
identifying that terms of auction have been met; and
sending notifications to the previous ad space possessor and the new ad space possessor.

6. The system of claim 1, the server having stored thereon computer instructions that during execution cause the system to perform operations further comprising:
gathering analytical data about at least one of the plurality of stored Internet-based ad spaces; and
presenting the analytical data to the authenticated users.

7. The system of claim 6 wherein analytical data includes clickstream data from a plurality of users.

8. The system of claim 6 wherein analytical data includes geospatial zone data.

9. The system of claim 1 wherein the Internet-based ad spaces are located on web platforms.

10. The system of claim 1 wherein storing the plurality of Internet-based ad spaces includes categorizing the ad spaces.

11. The system of claim 1 wherein the server manages the ad space on behalf of the ad space possessor.

12. The system of claim 11 wherein the server manages the ad space for the duration of the possessor's interest.

13. The system of claim 1 wherein the authenticated users view the posted ad spaces on the Internet-based user interface.

14. The system of claim 13 wherein the Internet-based user interface displays clickstream data of the posted ad spaces.

15. The system of claim 13 wherein the Internet-based user interface is customizable.

16. The system of claim 13 wherein the Internet-based user interface includes a current and constantly updated list of active bids on a posted ad space.

17. The system of claim 13 wherein the Internet-based user interface includes a displayed timer counting down to the expiration of a posted ad space.

18. The system of claim 13 wherein the Internet-based user interface includes a displayed timer counting down to the expiration of an ad space lease period.

19. The system of claim 1 wherein authenticating includes obtaining legal consent to host and manage ad spaces.

20. The system of claim 1, the server having stored thereon computer instructions that during execution cause the system to perform operations further comprising:
monitoring the system for fraudulent users; and
revoking authentication credentials for the fraudulent users.

21. The system of claim 1 wherein posting includes posting data with an expiration time and date of the posted ad space.

22. The system of claim 1, the server having stored thereon computer instructions that during execution cause the system to perform operations further comprising:
selling at least one of the plurality of Internet-based ad spaces to a first user of the authenticated users.

23. The system of claim 1, the server having stored thereon computer instructions that during execution cause the system to perform operations further comprising:
facilitating an exchange of at least two of the plurality of Internet-based ad spaces with a first user of the authenticated users and a second user of the authenticated users, wherein the first user is in possession of at least one of the at least two ad spaces and the second user is in possession of the rest of the at least two ad spaces.

24. The system of claim 1, the server having stored thereon computer instructions that during execution cause the system to perform operations further comprising:
leasing at least one of the plurality of Internet-based ad spaces to a first user of the authenticated users.

25. A method comprising:
authenticating a plurality of users via an Internet-based interface;
receiving a plurality of Internet-based ad spaces from the plurality of users after the authenticating;
storing the plurality of Internet-based ad spaces after the receiving; and
posting the ad spaces for the plurality of authenticated users to view after the storing.

26. The method of claim 25 further comprising:
auctioning at least one of the plurality of Internet-based ad spaces for bidding by the authenticated users.

27. The method of claim 26 wherein auctioning begins immediately after storing or a future time after storing.

28. The method of claim 26 wherein auctioning comprises:
identifying the ad space for auction has been bid on;
processing a valid input price from an authenticated user;
updating a displayed price instantaneously to reflect the valid input price; and
terminating the auction after a predetermined amount of time.

29. The method of claim 28 wherein auctioning further comprises:
identifying the ad space for auction has been purchased;
removing the ad space from posting;
identifying that terms of auction have been met; and
sending notifications to the previous ad space possessor and the new ad space possessor.

30. The method of claim 25 further comprising:
gathering analytical data about at least one of the plurality of stored Internet-based ad spaces; and
presenting the analytical data to the authenticated users.

31. The method of claim 30 wherein analytical data includes clickstream data from a plurality of users.

32. The method of claim 30 wherein analytical data includes geospatial zone data.

33. The method of claim 25 wherein the Internet-based ad spaces are located on web platforms.

34. The method of claim 25 wherein storing the plurality of Internet-based ad spaces includes categorizing the ad spaces.

35. The method of claim 25 wherein the server manages the ad space on behalf of the ad space possessor.

36. The method of claim 35 wherein the server manages the ad space for the duration of the possessor's interest.

37. The method of claim 25 wherein the authenticated users view the posted ad spaces on the Internet-based user interface.

38. The method of claim 37 wherein the Internet-based user interface displays clickstream data of the posted ad spaces.

39. The method of claim 37 wherein the Internet-based user interface is customizable.

40. The method of claim 37 wherein the Internet-based user interface includes a current and constantly updated list of active bids on a posted ad space.

41. The method of claim 37 wherein the Internet-based user interface includes a displayed timer counting down to the expiration of a posted ad space.

42. The method of claim 37 wherein the Internet-based user interface includes a displayed timer counting down to the expiration of an ad space lease period.

43. The method of claim 25 wherein authenticating includes obtaining legal consent to host and manage ad spaces.

44. The method of claim 25 the server having stored thereon computer instructions that during execution cause the method to perform operations further comprising:
monitoring the method for fraudulent users; and
revoking authentication credentials for the fraudulent users.

45. The method of claim 25 wherein posting includes posting data with an expiration time and date of the posted ad space.

46. The method of claim 25 further comprising:
selling at least one of the plurality of Internet-based ad spaces to a first user of the authenticated users.

47. The method of claim 25 further comprising:
facilitating an exchange of at least two of the plurality of Internet-based ad spaces with a first user of the authenticated users and a second user of the authenticated users, wherein the first user is in possession of at least one of the at least two ad spaces and the second user is in possession of the rest of the at least two ad spaces.

48. The method of claim 25 further comprising:
leasing at least one of the plurality of Internet-based ad spaces to a first user of the authenticated users.
